(19) United States
(12) Patent Application Publication
(10) Pub. No.: US 2008/0133258 A1
(43) Pub. Date: Jun. 5, 2008

(54) Method of fund raising for a predetermined cause utilizing a photo-mosaic composition

(76) Inventor: Leandros Kontogouris, Neo Psychico (GR)

Correspondence Address: Leandros Kontogouris, 28 Octobriou Street, #82, Neo Psychico, 15451, omitted

(21) Appl. No.: 11/929,904

(22) Filed: Oct. 30, 2007

Related U.S. Application Data
(60) Provisional application No. 60/863,617, filed on Oct. 31, 2006.

(51) Int. Cl. G06T 11/60; G06K 9/36; G06Q 99/00

(52) U.S. Cl. 705/1

(57) ABSTRACT

A method of fund raising for a predetermined cause utilizing a photo-mosaic composition with an appearance approximating a target image that is representative of the cause, the target image being compiled from source images contributed by participant individuals wishful of advancing the cause, wherein a web site is set to host a clickable icon file of the photo-mosaic composition associated with a database of participant profiles that is searchable through an incorporated search engine. The web site allows networking of participant individuals. The photo-mosaic composition is rendered through available rendering software in predetermined time intervals and periodical printouts thereof are produced to provide outdoor exhibits to be displayed in public, the scope of advancement of the predetermined cause and effective fundraising being achieved through the multiplier effect produced by the combination of outdoor and electronic promotional activities.

### CROSS REFERENCE TO RELATED APPLICATIONS

A claim of priority is made to U.S. Provisional Patent Application Ser. No. 60/863,617 filed Oct. 31, 2006, entitled: “Method for effective fundraising through the combination of outdoor advertising, photo-mosaics and marketing paradigms of internet communities”.

### BACKGROUND OF THE INVENTION

The present invention generally refers to a cause-related photo mosaic composition developed through computerized manipulation of photos and/or other identifying particulars submitted by a group of cause-sharing individuals and to a marketing system and method including periodic printouts of said cause related photo mosaic composition and forming an internet community amongst this group of individuals wherein procedures and operations are defined with a scope of advancing the cause depicted in said photo mosaic composition.

The digital composition of a mosaic image is known from U.S. Pat. No. 6,137,498 (Silvers) wherein is disclosed a method for generating a mosaic image with an appearance that approximates a target image by utilizing a plurality of source images and a computer, the method comprising the steps of loading the target image into the computer, dividing the target image into a plurality of tile regions, each tile region representing a distinct locus of the target image, dividing each tile into distinct sub-regions, comparing source images to the tile region to produce a measurement of visual similarity, selecting the source image with the highest measurement of visual similarity to represent the tile region and positioning the selected source image in the mosaic image at a locus corresponding to the locus of the tile region.

Various computer software packages have since emerged by means of which photo mosaic images are rendered that are made up of a plurality of smaller source images. Generally an average exceeding 1,000 source images is required in order to produce a quality photo mosaic and the higher the number of source images, the better the quality of the photo mosaic rendered.

Whilst digital composition of mosaic images has been used to produce artistically pleasing mosaic images employed in advertising and promotion activities, no mutually interconnecting cause is revealed shared by the individuals whose photographs are used as source images in the process of compiling the overall photo mosaic composition. Further, as the number of source images increases and the definition of the photo mosaic target image is improved, it becomes more and more difficult, if not impossible, for an individual whose photograph is employed as one amongst many source images in this respect, to locate the related source image within the photo mosaic composition.

The object of the invention is to provide a cause-related photo-mosaic composition wherein each individual participant submitting one or more source images and/or other identifying particulars to be used in compiling the overall photo mosaic image shares or is in one way or the other affiliated to a cause associated with the aforesaid cause-related photo-mosaic composition, whereby each individual through his participation satisfies his desire in promoting the cause associated with the cause-related photo-mosaic composition, whilst in the same time obtains priority privileges dependant upon his contribution in building up the cause-related photo-mosaic composition.

A further object of the invention is to provide computer software tools by means of which the aforementioned cause-related photo-mosaic composition is searchable and/or clickable and/or link enabling, thereby providing each individual participant shareholder or affiliate to the aforesaid cause-related photo mosaic composition with the capacity of locating a specific source image within the photo mosaic composition and/or clicking a specific locus within the photo mosaic composition to display a specific source image and/or link with detailed profile information and/or web site link addresses of the individual portrayed in the specific source image.

A further object of the invention is to provide said searchable photo-mosaic composition with the distinct feature of providing alternating displayed screens with participants, selected within the photo-mosaic or through the inbuilt search engine thereof, with a surrounding map of other participants with whom they are associated through sharing particularities as evidenced from their registration profiles.

Another object of the invention is to make the abovementioned display screens with surrounding maps of associated participants available even to newcomers immediately after clearance of their registration and even prior to the source photos submitted having become actual content of the photo-mosaic composition, thereby eliminating the need for frequent photo-mosaic re-rendering to include newcomers and effecting a substantial saving in the requirements and cost of the operational system.

A further object of the invention is to produce a dynamically evolving cause-related photo mosaic composition corresponding to the forming of the group of individuals sharing the cause associated with the cause-related photo-mosaic composition.

A further object of the invention is to propose a marketing system and method with a scope of effective fundraising amongst groups of individuals sharing a predetermined cause or affiliated to the same cause, the cause being illustratively depicted with the target image in said cause-related photo mosaic composition and the individuals being associated to the cause through providing source images for the composition of said photo mosaic composition, said method including in combination the steps of outdoor promotion by producing periodical printouts of said cause-related photo mosaic composition to be displayed in public and of electronic promotion by networking these individuals, setting up an internet community amongst them and applying procedures and operations with a scope of advancing the cause depicted in the photo mosaic composition and enhancing fundraising for said predetermined cause, wherein effective fundraising is achieved through the multiplier effect produced by the combination of outdoor and electronic promotional activities, while as more people adhere to the cause, the effect of reduced visibility of one single source image is no longer a disadvantage as it visually translates to the idea of every individual becoming integrated into a community for the advancement of their mutual cause, whereby individuality yields to the common ideal.

### BRIEF DESCRIPTION OF THE DRAWINGS

The invention will be made apparent to those skilled in the art by reference to the appended drawings in which:

FIG. 1 is a flow chart showing the steps of building a cause-related photo-mosaic composition and of using the same for producing a marketing system with a scope of effective fundraising amongst groups of individuals sharing the cause illustratively depicted in the target image of the photo-mosaic composition.

FIG. 2a is a flow chart of the process of submission of a source image of an individual and administrator editing and controlling steps to enable incorporation of the submitted source image in the photo-mosaic and to enact registered member status of the individual participant.

FIG. 2b is a flow chart of the web site operation process.

FIG. 3 is a flow chart describing the process of navigation through the web site designed to promote the cause related photo-mosaic composition for the alternative statuses of a visitor and of a registered member.

FIG. 4 is the original of an illustrative picture that is being selected as the target image of a cause-related photo-mosaic composition.

FIG. 5 shows the photo-mosaic composition being rendered with a scope of depicting the selected target image depicted in FIG. 4 with clickable and/or linkable tiles corresponding to the source images contributed by cause-sharing individuals.

FIG. 6a-6g illustrates sequential steps in the process of navigation and searching through the photo-mosaic composition.

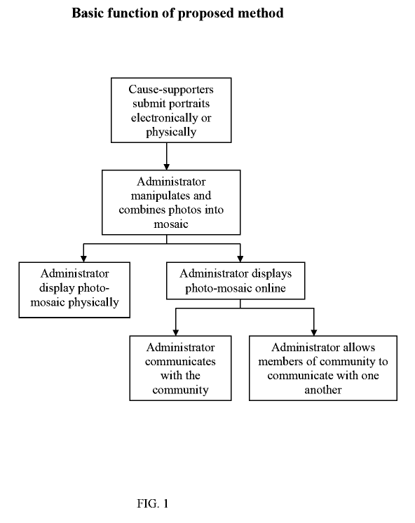

### DETAILED DESCRIPTION OF PREFERRED EMBODIMENTS

The invention discloses a method of effective fundraising amongst groups of individuals sharing a predetermined cause or affiliated to the same cause. The method comprises a first step of selection of at least one image representative of the cause to be promoted and inviting a target group of potential cause-sharing individuals to actively contribute through submission of their photographs and/or other identifier particulars with a scope of building up a cause-related photo-mosaic composition with an appearance approximating the selected image representative of the cause, whereby such photo-mosaic composition will henceforth effectively operate as a photo-petition medium for promoting the cause illustratively depicted in the selected target image of the photo-mosaic composition.

The method further comprises the step of setting up a database of the source images being submitted by cause-sharing individuals and of using this database in combination with appropriate photo-mosaic composing software tools to build up the photo-mosaic composition, the appearance of which approximates the selected target image representative of the cause to be promoted. Submission of each source image is accompanied with the payment of a fee and the resources obtained from fees being paid are used exclusively in promotional activities associated with the advancement of the cause shared by the individual participants who have contributed source images to be incorporated in the selected target image that is representative of the cause and is portrayed in the photo-mosaic composition. As membership of the database grows with more source images being submitted, the target image is more and more clearly rendered in the photo-mosaic composition, thereby enhancing the cause promoting scope, whilst the increased population of source images leads to an increased difficulty in locating a specific source image within the photo-mosaic composition, yet creating a visual depiction of the act of complete and seamless integration in a cause sharing group.

To enable locating a specific source image within the plurality of source images composing the photo-mosaic composition a search engine is set up enabling authorised users to access the database and locate a specific source image within the photo-mosaic composition.

In accordance to a preferred embodiment of the invention the dynamically evolving photo-mosaic composition becomes the core content of a web site designed to serve the same scope, wherein one may obtain access to the database compiled with all participant individuals whose pictures have been submitted and have become part of the photo-mosaic composition. The cause-related photo-mosaic composition therefore becomes the means of networking the group of individuals, cause-sharing participants who may set up and share various activities within the framework of the web site, e.g. chat rooms, online forums, blogs, email accounts, links to other social network web sites (e.g. Facebook, Myspace, etc.), on line communication services (e.g. Yahoo Messenger, MSN Messenger, etc.), thereby socializing and communicating with a scope of advancement of the cause.

The dynamically evolving photo-mosaic composition is periodically suitably printed to provide outdoor exhibits that may take any form suitable for the attraction of interest of viewers. By way of example large banners may be printed to be appropriately suspended onto advertising designated spaces or onto the facades of buildings or be flown in the sky being carried by aircraft or hot-air balloons or they may form the decorative covering of the hot-air balloon itself, etc. Places of high symbolic value and/or symbolic dates are preferably selected for exhibiting the photo-mosaic composition with a scope of enhancing participation therein and strengthening the message to be transmitted in support of the predetermined cause.

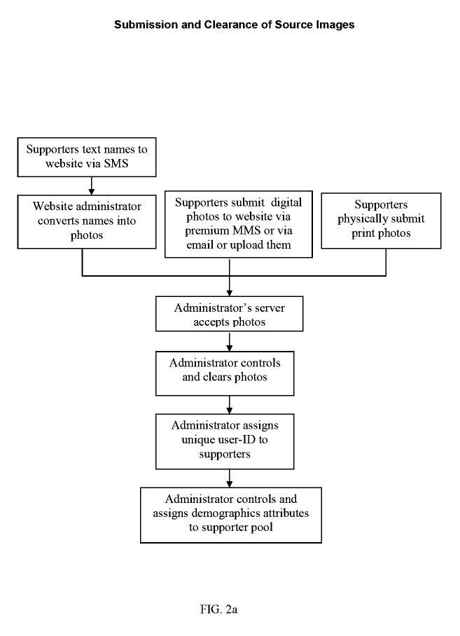

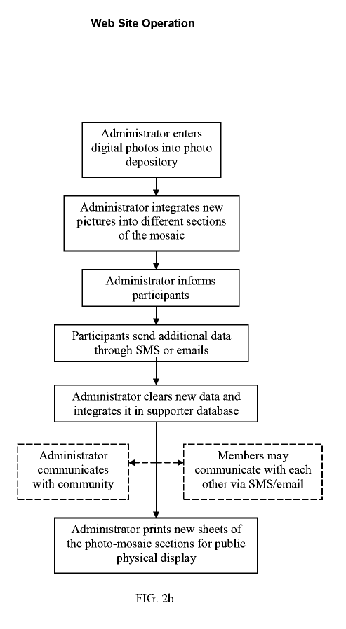

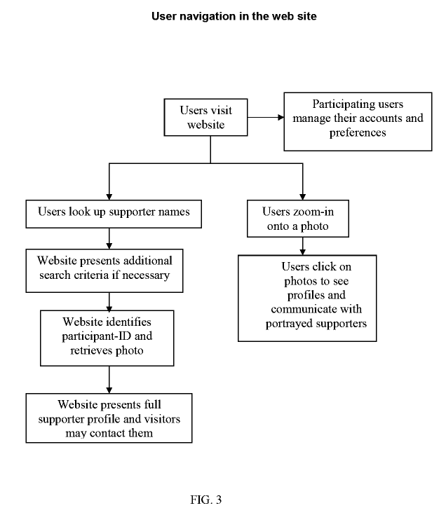

As shown in the flow chart of FIG. 2a photos may be submitted by individuals joining in supporting the cause in any available mode whatsoever. Portraits and photographs may be submitted either physically printed on paper or electronically. If submitted physically the administrator undertakes to scan the printed photograph and produce a digital equivalent thereof. Electronic submission may be effected through e-mail attachments or authorized downloading from a web site. Alternatively the cellular telephony or other similar networks can be used, whereby pictures may be submitted as photographic short messages transmitted via the Multimedia Messaging System (MMS) service provided by various cellular telephony providers. If an individual chooses to submit other identifying particulars, such as his name or a logotype or other non-pictorial representation, that may also be submitted as an SMS, the administrator undertakes to convert such message into a pictorial form appropriate for incorporating within the cause-related photo-mosaic composition. An integrated photo and/or other identifying particulars submission and registration menu incorporating an online billing service is also made available within the web site address of the cause-related photo-mosaic composition. Independently of the manner in which an individual participant selects to submit his photograph or other identifying particulars, submission is accompanied by the payment of a predetermined fee, which in the case of physical submission may be paid to the administrator in cash or through credit card or bank check or bank or giro transfer or other appropriate means available, whilst in the case of transmission through an intermediate, such as by way of example the cellular telephony provider for SMS or MMS transmission, arrangements may be concluded with the provider to charge a premium fee for such SMS or MMS transmission and return an agreed percentage of such premium fee to the administrator of the cause-related photo-mosaic composition.

Following submission of each photo and/or other identifying particulars and completion of the digitization process thereof, the photos and/or other identifying particulars of individual participants are stored within a first electronic general photo depository. Then administrator performs a controlling procedure wherein a series of predetermined checks and/or edits are made on submitted photos or other identifying particulars, e.g. check as to decency and appropriateness and clearance of the payment of the predetermined fee that has to accompany each photo submission, or fix the colors of an overexposed photo. Following completion of this controlling procedure appropriately cleared photos are transferred from the abovementioned first general photo depository to a second depository of approved photographs. At the same time a unique user-ID is issued and sent to the participant and a profile of the participant is filled and loaded in the database of participants according to submitted information associated with the unique user-ID assigned and to the photograph submitted. Immediately after completion of this process and whilst his photo has not yet been incorporated within the cause-related photo-mosaic composition, the new participant can log-in and perform in depth search of the photo-mosaic enabled to access full profiles of other participants and communicate with them.

The photo-mosaic composition is periodically renewed to include photos and/or other identifying particulars contributed during predetermined submission periods in between successive renewed renderings of the overall photo-mosaic composition. In accordance to a preferred embodiment of the invention a procedure with predetermined rules is followed in order to assign the locus within the overall photo-mosaic wherein each photo or other identifying particular pertaining to each individual participant is positioned. One positioning rule might be associated with the mode and content of submission. By way of example a submission comprising only name of participant (plain SMS) is placed at the periphery of the target photo and if comprising plain MMS photo is placed mid-way in the target photo. If the submission is a premium MMS comprising photo and full profile it is advantageously positioned close to the center of the target photo. Since submission of a full profile leads to advantageous positioning within the photo-mosaic and furthermore naturally leads to the portrayed supporter attracting more attention by getting in the spotlight and being easier located by other members of the community, it is always possible for participants who initially participated with a plain photo or other identifying particular to later submit a full profile naturally accompanied with payment of an increased predetermined fee, so as to enjoy the privileges of premium participation in the photo-mosaic composition and improve their communication capacity with the photo-mosaic related community.

As the photo-mosaic composition is periodically re-rendered and updated with incorporation of new submissions, each participant is allocated a new positioning within the photo-mosaic depending on the level of activity he has developed in supporting and promoting the cause, such level of activity being evidenced through his personal account with the system, such account being continuously updated to include credit points allocated according to predetermined rules for various supportive activities, such as recruitment of new participants, contributions in sponsoring cause promotional events or submission of valuable cause promoting ideas.

Besides from being awarded merit by being depicted at advantageous positions within the photo-mosaic, pictured participants, depending on the level of their activity in propagating the cause including their successful recruitment of new participants and possibly their spiritual or financial contribution in the form of sponsorship of web site or outdoor promotion activities, may earn additional privileges in the community, such as being awarded honorary titles or administrative privileges for a section of the community or privileges of a general nature, such as sweepstake tickets, discounts, gifts contributed by sponsors, etc. In accordance with a preferred embodiment of the invention for the purpose of identification and the ensuing fair distribution of privileges, new supporters that were brought in by older ones, will have to make reference to the user-ID of the person that introduced them to the project in the first place. The introducing participant thereby earns credit points from the new participant being introduced and will continue earning credit as in turn the new participant proceeds with his own recruiting activity to introducing further new participants.

In order to facilitate rendering of the photo-mosaic through taking into consideration the above dynamically variable parameters, the photo-mosaic may be appropriately divided into a number of different sections, each section constituting an individually managed mosaic of a portion of the target photo to be depicted in the photo-mosaic composition, all different sections being hereinafter compiled to produce the overall target photo in the cause-related photo-mosaic composition. Each participant may declare a preference for participation in one or another section during registering his profile or through editing the same thereafter. The shape, size and resolution corresponding to the number of participant photos for each one of the different sections may change as the process of new submissions builds up. According to a preferred step in the method of the invention one of the awards for participants actively involved in promoting the cause would be their assignment with the Ambassador status and the naming after them of a particular such section of the photo-mosaic. The ever evolving photo-mosaic composition may therefore be appropriately divided into an increasing number of sections named after an increasing number of new Ambassadors and whilst maintaining a nominal surface area total, e.g. of 700 m², it may begin with 7 sections of an average size of 10 m² each and end up with 700 sections of an average size of 1 m² each. Naturally sections named after individual ambassadors may in the course of time have varying sizes depending on the continuing relative recruiting activity of the ambassador and members of each specific section and on the preferences expressed by newly registered participants. Ambassador related sections of the photo-mosaic are naturally part of the broader sections being managed by the administrator on the basis of the type of submissions made and on the level of activity of individual participants.

The web site established with the core content of the dynamically evolving cause-related photo-mosaic composition may include various pages, such as Mission Statement, News, Chat rooms, menus for registration of new participants and of account editing of old ones, etc., but the core content thereof is the searchable, clickable and/or linkable photo-mosaic composition itself.

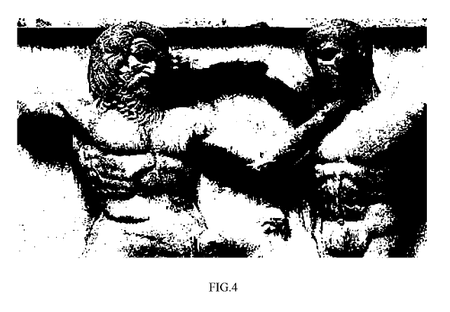

FIG. 4 illustrates the real image of an ancient Greek sculpture from a Metope of the Athens Parthenon and FIG. 5 shows a photo-mosaic composition thereof. Such a target image might be illustratively used to develop a fund raising activity related to the cause of the preservation of global cultural heritage and it can attract attention of a global audience especially if associated with scheduled outdoor events of exhibiting the cause-related photo-mosaic composition e.g. through a banner to be hung close to Athens Parthenon or suspended from an air balloon flying nearby.

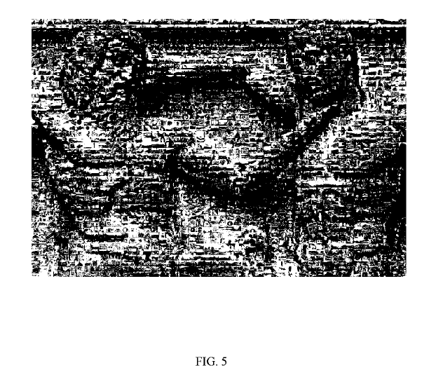

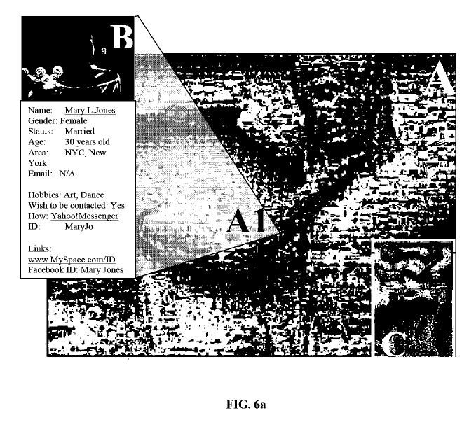

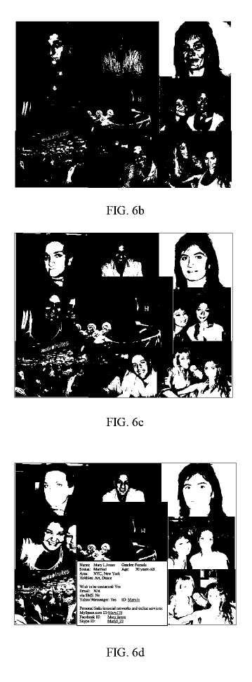

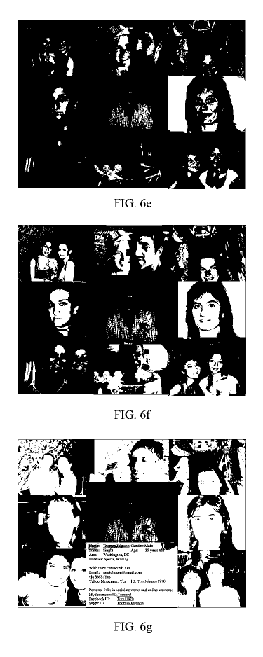

Then FIGS. 6a-6g illustrate an indicative series of sequential steps in the process of navigation and searching through the photo-mosaic composition. At the first place one may choose to zoom in the overall photo-mosaic picture in order to magnify a certain area thereof that might correspond to a selected ambassador area. In FIG. 6a “A” denotes such a zoomed-in part of the photo-mosaic of FIG. 5, whilst in accordance with a preferred mode of implementing the invention the overall photo-mosaic continues to appear at the bottom right corner denoted by letter “C”. Clicking at a particular point of the photo-mosaic, as shown by indicative arrow A1, a side picture B appears wherein is depicted the profile of the participant whose source image is located at such locus of the photo-mosaic composition. Alternatively a user can arrive at the same picture through the inbuilt search engine feature of the photo-mosaic available to visitors of the related web site by submitting a query based on the name and if necessary additional criteria.

In accordance with a preferred embodiment of the invention with a scope of stimulating interest and enhancing traffic in the web site, following zooming-in at the level of a specific photo-mosaic participant, the inbuilt software activates a logical algorithm by means of which a number of appropriate persons related to the pictured participant through one or more amongst a multiple variety of particular similarities are being selected and appear around him/her (FIG. 6b). Clicking onto a certain picture within this small mosaic results in further magnifying of this specific picture and differentiated illumination thereof in relation to adjacent shaded pictures (FIG. 6c). Next clicking results in presentation of the profile of the selected illuminated participant (FIG. 6d). If now the user wishes to explore the profiles of surrounding participants and chooses e.g. the person on top of the former centrally depicted participant, then this participant becomes center of the picture (FIG. 6e) and by proceeding further as hereinabove this picture is at first magnified and differentially illuminated (FIG. 6f) and subsequently the profile of the selected participant appears. In accordance to a preferred embodiment of the invention the abovementioned logical algorithm software tool applies randomly selected criteria and/or follows very specific rules in order to produce the map of participants surrounding a selected and/or searched individual, thereby achieving enhancement of traffic, since the same participant every time appears surrounded by other participants, some of whom might be the same and others might be different in successively produced screens.

Whilst as mentioned hereinabove, it may take some time for the newly registered members to actually be depicted within the target image of the cause-related photo-mosaic composition, since the latter is preferably re-rendered at predetermined time intervals, it is however possible for the new corner to immediately make use of the search and display feature with the surrounding of participants sharing common particularities. Such provision of search and display feature provides the impression of the new corner being immediately incorporated in the photo-mosaic composition and saves from extensive requirements of rendering power, bandwidth, server space and other system requirements that would apply if re-rendering of the photo-mosaic were to become a continuously operative process.

The herein above described process and tools does not necessarily apply to causes falling within the sphere of social responsibility, but may also be practiced to serve all communication purposes, including strictly commercial ones.

1. A method of fundraising for a predetermined cause utilizing a photo-mosaic composition with an appearance approximating a target image that is representative of said predetermined cause, said target image being compiled from source images contributed by participant individuals wishful of advancing said predetermined cause, the method comprising in combination:
setting up a web site hosting a clickable icon file of said photo-mosaic composition and networking participant individuals who submit source images with a scope of forming said target image representative of the predetermined cause through repetitive rendering of the photo-mosaic composition in predetermined time intervals to integrate within the photo-mosaic source images submitted in between two successive time intervals, and
producing periodical printouts of said photo-mosaic composition with said target image that is representative of said predetermined cause to provide outdoor exhibits to be displayed in public, wherein the scope of advancement of said predetermined cause wherein effective fundraising is achieved through the multiplier effect produced by the combination of outdoor and electronic promotional activities.

2. The method of fund raising of claim 1, further comprising the steps of:
receiving source images and predetermined accompanying fees submitted by participant individuals wishful of advancement of said predetermined cause with a scope of their source images being incorporated within said photo-mosaic composition and of the fees being used with a scope of advancement of said predetermined cause;
storing source images being received within a first general photo depository;
performing a series of predetermined checks on said source images being stored within said first general photo depository and clearance of the payment of said predetermined accompanying fees;
transfer of said source images following completion of checking thereof and clearance of the payment of said predetermined accompanying fees to a second depository of approved source images, and
issuance of a unique user-ID for each individual participant submitting an approved source image and filling out a profile of the individual participant based on information supplied by the participant and loading said profile in a database incorporating profiles of all individual participants, each profile associated with the unique user-ID of the particular individual participant.

3. The method of fund raising of claim 2, further comprising the steps of enabling searching within said database of the profiles of participant individuals to locate a particular individual participant through clicking onto a source image of said particular participant within said clickable icon file of said photo-mosaic composition and/or through submitting a name query and/or other identifying particular query to an inbuilt search engine;
initiating execution of a logical algorithm each time a particular participant is searched to produce a list of participants associated with said particular participant in a randomly selected assortment of particularities and displaying a screen of a particular participant searched surrounded by a number of other participants of said list of participants associated with said particular participant in a randomly selected assortment of particularities.

4. The method of fund raising of claim 3, wherein said execution of a logical algorithm each time a particular participant is searched to produce a list of participants associated with said particular participant in an assortment of particularities selected randomly and/or following very specific rules and displaying a screen of a particular participant searched surrounded by a number of other participants of said list of participants associated with said particular participant in a randomly selected assortment of particularities is made available for each individual participant immediately after completion of the clearance procedure following submission of his source image and prior to the actual integration of the source image in the photo-mosaic composition.

5. The method of fund raising of claim 1, further comprising the step of reassigning positioning of the source image of each individual participant within said photo-mosaic composition depending on the level of activity each said individual participant has developed with a scope of supporting and promoting the cause in the time interval from the immediately prior rendering of the photo-mosaic composition.

6. The method of fund raising of claim 1, further comprising the step of maintaining an account of each one of the individual participants wherein are being stored participants recruited and introduced in submitting source images to be compiled within said photo-mosaic composition through said each one of the individual participants and allotting privileges to individual participants achieving notable recruitment of new participants including awarding ambassador status and naming after them particular sections of the photo-mosaic composition.

7. A photo-mosaic composition adapted to be used in a fund raising activity for a predetermined cause, said photo-mosaic composition depicting a target image that is representative of said predetermined cause, said target image being compiled from source images contributed by participant individuals wishful of advancing said predetermined cause, said photo-mosaic composition being rendered through photo-mosaic rendering software in a computer and periodically printed to produce outdoor exhibits for promotion of the fundraising activity.

8. The photo-mosaic composition of claim 7 constituting a clickable icon file incorporated in a web site and associated with a search engine and a database wherein are entered the profiles of individual participants who have contributed source images to become part and form said target image of the photo-mosaic composition.

9. The photo-mosaic composition of claim 7 printed onto a large banner to be appropriately suspended onto advertising designated places or be flown through being carried by aircraft or hot-air balloons.
